(19) United States
(12) Patent Application Publication
(10) Pub. No.: US 2021/0078644 A1
(43) Pub. Date: Mar. 18, 2021

(54) Multi-Purpose Headache Rack

(71) Applicant: Jack Farren, Capitola, CA (US)

(72) Inventor: Jack Farren, Capitola, CA (US)

(21) Appl. No.: 16/572,162

(22) Filed: Sep. 16, 2019

(51) Int. Cl. B62D 33/02; E05F 15/627

(52) U.S. Cl. CPC B62D 33/0207; B60Q 1/18; E05F 15/627

(57) ABSTRACT

A truck rack apparatus has a rack framework comprising two vertical posts at opposite sides of a bed of the truck proximate a cab of the truck, the posts extending to a height beyond a height of the cab of the truck, a top rail spanning between the two vertical posts near an upper extremity of the posts, mounted to rotate about a horizontal axis, and a substantially rectangular planar panel rigidly joined along one edge to the top rail, such that the planar panel is rotatable about the horizontal axis to assume a first position with the plane of the panel vertical, and the panel suspended from the top rail between the vertical posts, occluding a back portion of the cab of the truck, and a second position with the plane of the panel horizontal, projecting over the cab, serving as a cargo panel for carrying cargo.

### BACKGROUND OF THE INVENTION

### 1. Field of the Invention

The present invention is in the technical area of add-on apparatus for use with trucks and pertains more particularly to a headache rack that has a fold over panel.

### 2. Description of Related Art

Headache racks are well-known in the art and provide protection for a truck cab and rear window from cargo carried in a bed of the truck, such as a pickup truck. Conventional headache racks that protect the cab and back window typically have a vertical panel that makes it difficult or impossible to clean the back of the truck cab or the rear window of the truck. Conventional headache racks also do not provide additional cargo-carrying capability.

What is needed is a headache rack that has a panel that protects the back of the truck and rear window, but that may be moved for cleaning access, and that may also provide additional functionality.

### BRIEF SUMMARY OF THE INVENTION

In one embodiment of the invention a truck rack apparatus is provided, comprising a rack framework comprising two vertical posts, one each at opposite sides of a bed of the truck proximate a cab of the truck, the posts extending to a height beyond a height of the cab of the truck, a top rail spanning between the two vertical posts near an upper extremity of the posts, the top rail mounted to rotate about a horizontal axis between the vertical posts, and a substantially rectangular planar panel rigidly joined along one edge to the top rail, such that the planar panel is rotatable about the horizontal axis to assume a first position with the plane of the panel vertical, and the panel suspended from the top rail between the vertical posts, occluding a back portion of the cab of the truck, and a second position with the plane of the panel horizontal, projecting over the cab of the truck, serving as a cargo panel for carrying cargo.

In one embodiment the apparatus further comprises a locking mechanism that, engaged, holds the planar panel in the first position. Also, in one embodiment the truck rack apparatus further comprises a stop mechanism joined to one or both of the vertical posts, such that the planar panel, when rotated to the second position encounters the stop mechanism, which constrains the planar panel in the horizontal position over the cab of the truck. In another embodiment the top rail comprises a tubular portion engaging bearings, one proximate each end of the top rail, the bearings engaging a rod spanning between the two vertical posts, such that the tubular portion rotates freely with respect to the rod. And in one embodiment the bearings are polymer journal bearings.

In one embodiment the apparatus further comprises an electric motor drive apparatus engaging the top rail, such that the motor engaged in one rotary direction rotates the top rail, moving the planar panel from the first to the second position, and engaged in an opposite rotary direction rotates the planar panel from the second position to the first. Also, in one embodiment the electric motor drive apparatus further comprises a chain and sprocket arrangement, one sprocket engaged to an output shaft of the motor, and a second sprocket engaged to the top rail. In one embodiment the substantially rectangular planar panel has a framework formed of rectangular steel tubing, with a panel of expanded metal joined to the framework. In one embodiment the apparatus further comprises a plurality of retainer clips joined to the framework, providing attachment points for cargo lines or bungee cords to retain cargo placed on the panel. And in one embodiment the apparatus comprises four vertical posts, one each at each of four corners of the bed of the truck, the posts joined by horizontal rails, providing a full cargo rack system.

### BRIEF DESCRIPTION OF THE SEVERAL VIEWS OF THE DRAWINGS

FIG. 1 is a perspective view of a pickup truck with a dual-purpose headache rack according to an embodiment of the present invention.

FIG. 2 is a perspective view of the pickup truck of FIG. 1 with the headache rack configured in an alternative manner.

FIG. 3 is a broken section illustration of a portion of a top rail and an upper portion of posts of the headache rack of FIGS. 1 and 2.

FIG. 4 is a perspective view of one of bearings in an embodiment of the invention.

FIG. 5 is a side elevation view of the headache rack of FIGS. 1 and 2 shown bolted to the side rails of the truck with a cargo rack over a top of the cab of the truck.

FIG. 6 is a view of an assembly similar to that of FIG. 3, showing an alternative embodiment of the invention.

FIG. 7 is a perspective view of a pickup truck with a dual-purpose headache rack according to an alternative embodiment of the present invention.

FIG. 8 is a perspective view of the apparatus of FIG. 7 in an alternative configuration.

### DETAILED DESCRIPTION OF THE INVENTION

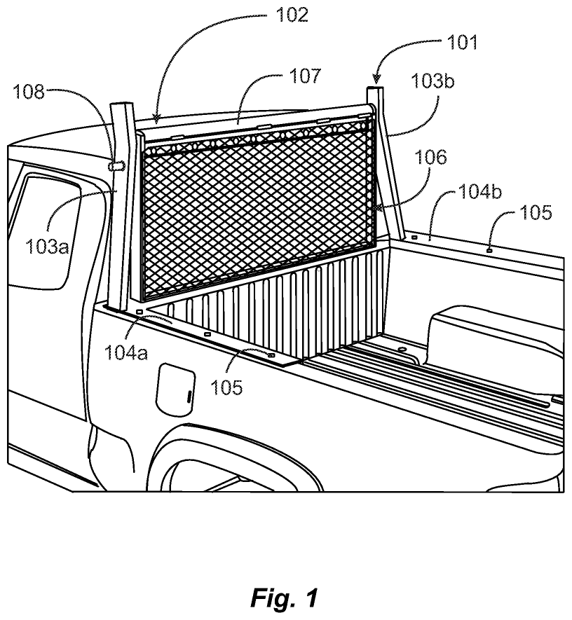

FIG. 1 is a perspective view of a pickup truck 102 with a dual-purpose headache rack 101 according to an embodiment of the present invention. Headache rack 101 comprises in this example opposite vertically oriented posts 103a and 103b that extend vertically from a framework that comprises horizontal rails 104a and 104b that fasten to a top surface of the sides of the truck bed by conventional fasteners 105, such as hex head bolts, for example. The posts may be, in one embodiment, welded to the frame rails.

Headache rack 101 in this example further comprises a substantially rectangular panel 106 that has a framework of side rails to which expanded metal is attached, such as by welding. Panel 106 is rigidly attached to a round top rail 107 that rides on a pivot axis between posts 103a and 103b, such that panel 106 may rotate around the pivot axis from the apparent vertically suspended position shown in FIG. 1 to assume other positions. In the vertically suspended position shown in FIG. 1 panel 106 protects the back of the truck cab and the rear window of the truck cab from damage that might be caused by cargo in the truck bed. It may be noted that the pivot axis and top rail 107 are implemented at a height on the posts that is above the upper extremity of cab

In the example illustrated in FIG. 1 a pin mechanism 108 through post 103a is provided to lock panel 106 in the vertically suspended position shown, protecting the back and rear window of the cab of the truck. Pin 108 in this example may be advanced to engage a hole in the frame of panel 106, and the pin may be locked in the forward position by, for example, a cotter key. The key may be released, and the pin withdrawn to release panel 106 such that the panel may be rotated around the pivot axis that is also the longitudinal axis of top rail 107. There may be a second pin mechanism through post 103b. There are a variety of ways such a locking mechanism may be implemented. For example, rather than a pin, there may be a male threaded hole through post 103a and instead of a pin through the post there may be a threaded rod with a knob on an outside end, such that the knob may be rotated to advance the threaded rod to engage the side frame of panel 106.

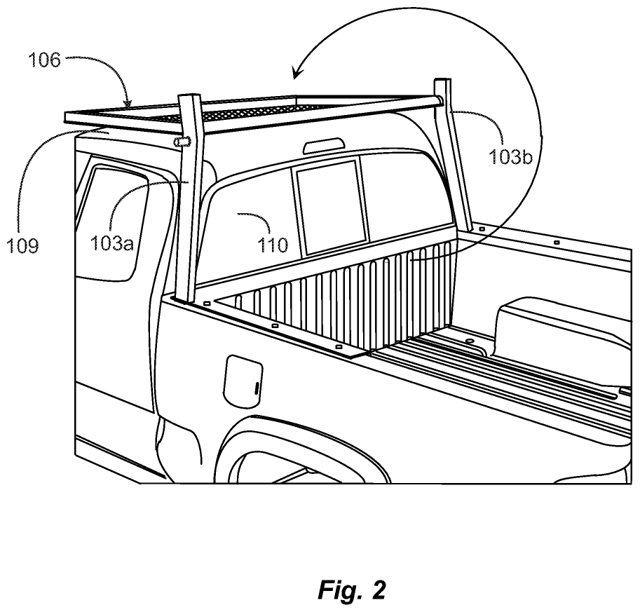

FIG. 2 is a perspective view of the pickup truck of FIG. 1 with the headache rack configured in an alternative manner. In the example illustrated in FIG. 2, pin mechanisms 108 have been withdrawn, and panel 106 has been manually rotated around the pivot axis of top rail 107 to lie horizontally over cab 109 of truck 102. In this position panel 106 provides a cargo rack for a user to place and carry cargo, such as coolers, rolled tents, and any other cargo that may be desired to carry, that is within the dimensional boundaries of panel 106. In the configuration shown in FIG. 2 the rear of the cab and the rear window are accessible and may be cleaned and maintained. With a conventional headache rack having a stationary vertical rear panel, the rear window and rear surfaces of the cab are not accessible and are even difficult to clean.

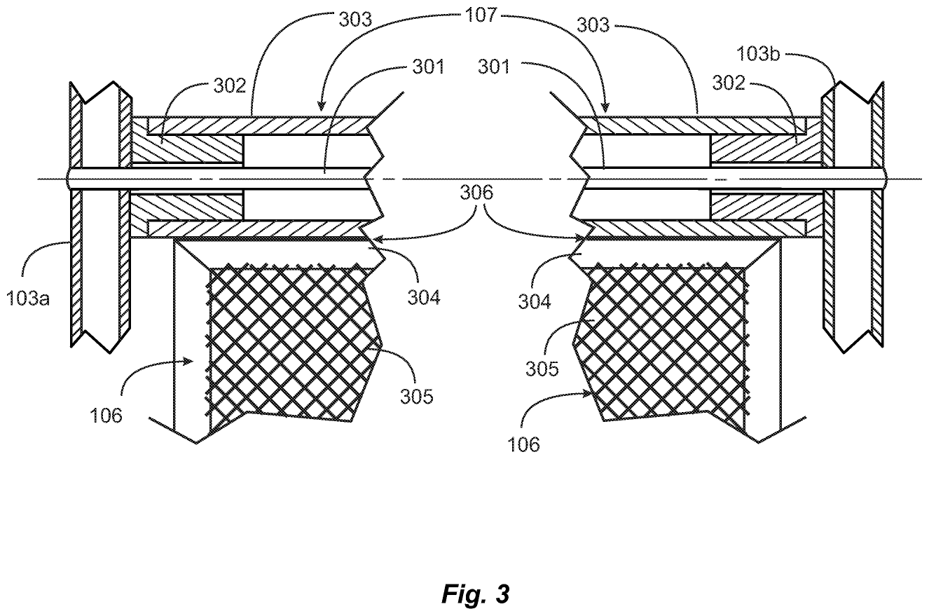

FIG. 3 is a broken section illustration of top rail 107 and an upper portion of posts 103a and 103b, including panel 106. This section is broken lengthwise so portions at each end may be illustrated magnified to show detail. A solid rod 301 in this example extends between and through both posts 103a and 103b and is welded to the posts at least at the outboard ends. Rod 301 forms an axle upon which top rail 107 may pivot, and spaces the posts apart. Top rail 107 comprises a length of steel pipe 303 in this embodiment, which engages a diameter of each of two nylon journal bearings 302. An inner bore of the bearings is a slip fit to an outer diameter of rod 301, such that the bearings may freely turn on the rod. Panel 106, comprising an outer frame 304 made from square steel tubing with expanded metal welded to the frame, is welded to pipe 303 along line 306.

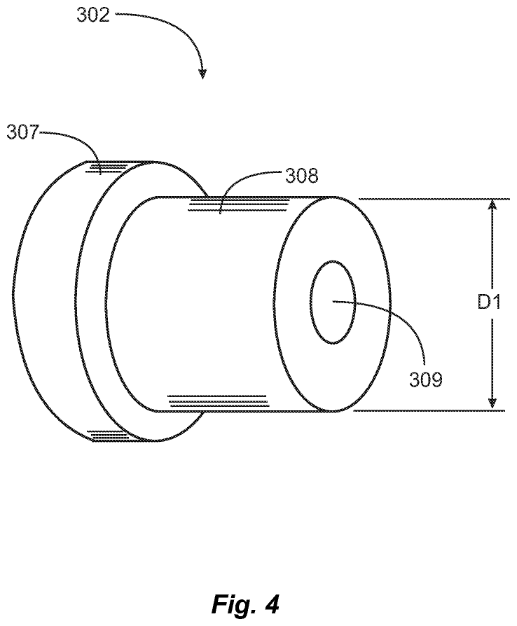

FIG. 4 is a perspective view of one of nylon journal bearings 302. The bearing has a shoulder end 307, which may be seen in FIG. 3 to provide a bearing surface against posts 103a and b in operation. The bearing has a body portion 308 with a diameter D1 that is substantially the inside diameter of steep pipe 303, such that the bearings may be press fit into the pipe at each end. Bore 309 is slightly greater in diameter than the outside diameter of rod 301, such that the bearing and pipe assembly, comprising top rail 107, may turn freely on rod 301.

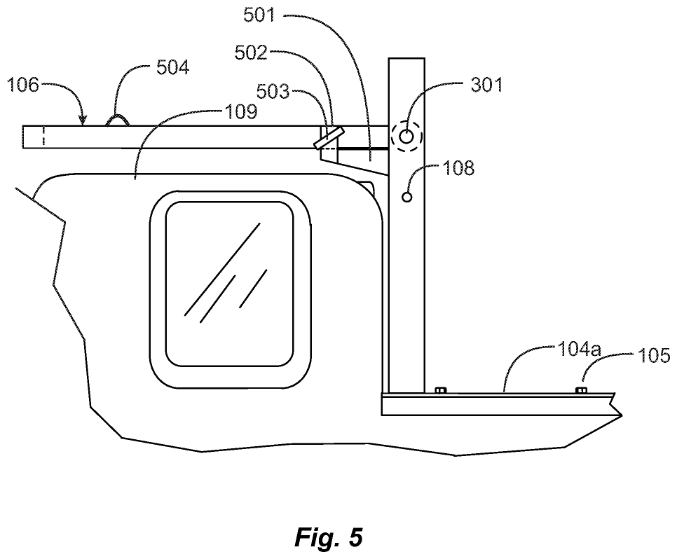

FIG. 5 is a side elevation view of headache rack 101, shown bolted through panels 104a and 104b by bolts 105, to the side rails of the truck bed, with posts 103a and 103b extending vertically proximate the back of the cab of the truck. In this view panel 106 is in the rotated deployed position over the top 109 of the cab of the truck, in which position a user may store cargo on the rack. One clip 504 is shown, of which there may be a plurality in some embodiments, to which tie-downs or bungee cords may be hooked to aid in storing cargo.

A stop shelf 502 is shown that in this example is welded to a front surface of post 103a, for a purpose of stopping rotation of panel 106 to extend horizontally over the cab. There may be a second such stop shelf welded to post 103b (not seen in FIG. 5. In some embodiments a side panel 502 may be added with a pin that may extend into a hole in the frame of panel 106, to hold the panel in place. The pin may be manipulated by a handle 503. The skilled person will understand that there me a variety of ways that stops may be implemented to position panel 106 over the cab of the truck.

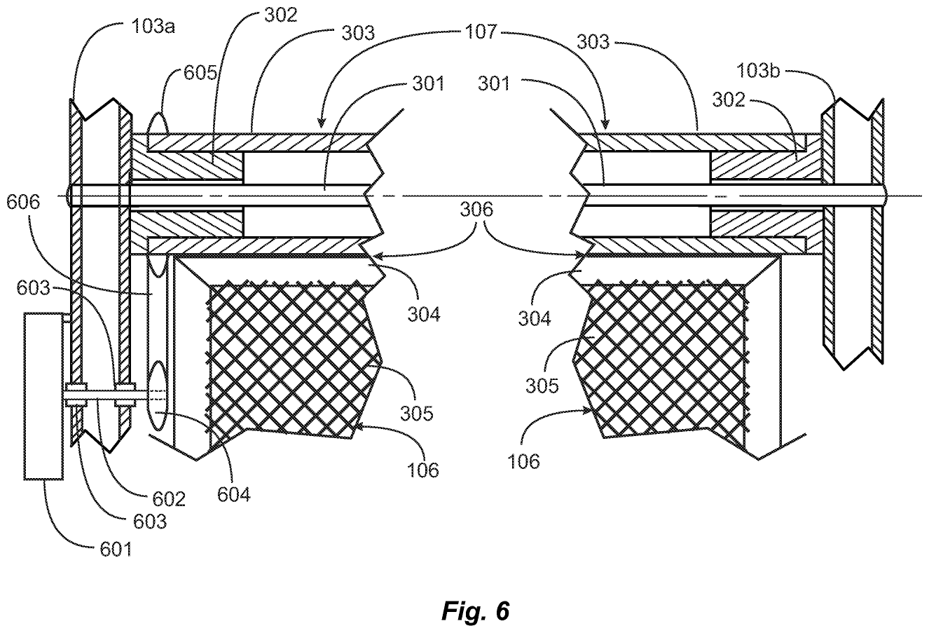

FIG. 6 is a view of an assembly similar to that of FIG. 3, showing an alternative embodiment of the invention, in which the top rail 107 may be rotated by an electric motor 601 driving a shaft 602 through bearings 603 through post 103a, to a first sprocket 604 which is engaged to a second sprocket 605 that is fastened to pipe 303 of top rail 107. The first sprocket drives the second sprocket through chain 606. Motor 601 in one embodiment may be powered by the battery of the truck and may be controlled through switch inputs in the cab of the truck, enabling a user to switch on the motor in one direction to raise panel 106 from a first position at the back of the cab to a second position over the cab as shown in FIG. 5. In this embodiment pins to hold the panel in place may not be necessary, as the sprocket engagement with the motor may well be sturdy enough to secure the panel.

In other embodiments there may be gears rather than a chain and sprockets, and the skilled person will understand that there are alternative ways that a drive may be implemented to accomplish the purpose. Further, there may be embodiments wherein a manual system may be implemented similar to a motor-driven system, but power to rotate the top rail 107 may be provided by a crank to be turned by the user.

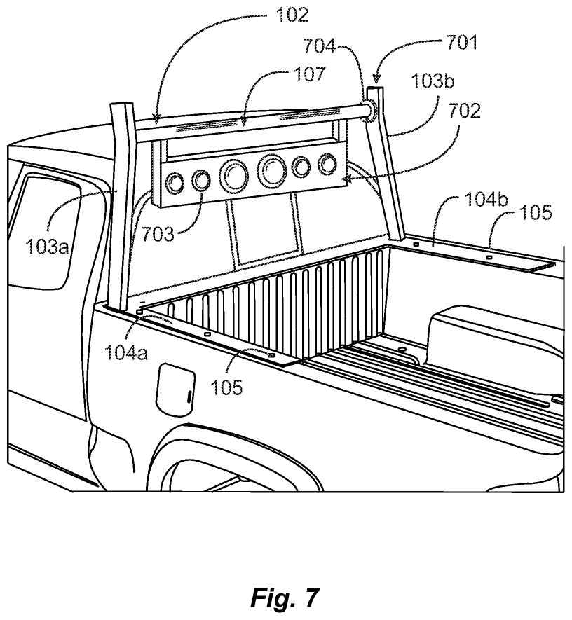

In another aspect of the invention a light bar may be joined to rotary top rail 107 and may be manipulated between two positions in a manner similar to that described above for a cargo panel. FIG. 7 is a perspective view of pickup truck 102 having a headache rack 701 with a rotating top rail 107 engaged with journal bearings just as is top rail 107 of headache rack 101 illustrated in FIG. 1. Top rail 107 in FIG. 7 is implemented as shown in FIG. 3 with bearings 302 engaging a pipe as shown in FIG. 4. In headache rack 701 a light bar 702 is suspended from the pipe portion of top rail 107 rather than a cargo panel, as shown in FIG. 1.

Light bar 702 in this example is based on a framework made from square or rectangular steel tubing but may be implemented in a variety of ways to provide a base for lights 703, that are mounted on the light bar. The lights may comprise a number of units of different sizes and colors and are mounted to project to the rear of the truck when the light bar is in the suspended position shown in FIG. 7. For example, two of the lights may be used as additional turn signal lights to the turn signal lights of the truck itself. Other lights may be for white light illumination, to provide working light to the bed of the truck.

In FIG. 7 a locking mechanism 704 is provided based on a metal disk that is welded to the pipe portion of top rail 107, near one end. The disk has a through hole which may engage a first pin through post 103b in this view, that constrains the light bar in the suspended position shown.

It should be noted that with the light bar in the suspended position shown in FIG. 7 that top rail 107 provides a supporting rail for such as lumber and other items that may be transported in the bed of the truck, as is expected for a headache rack.

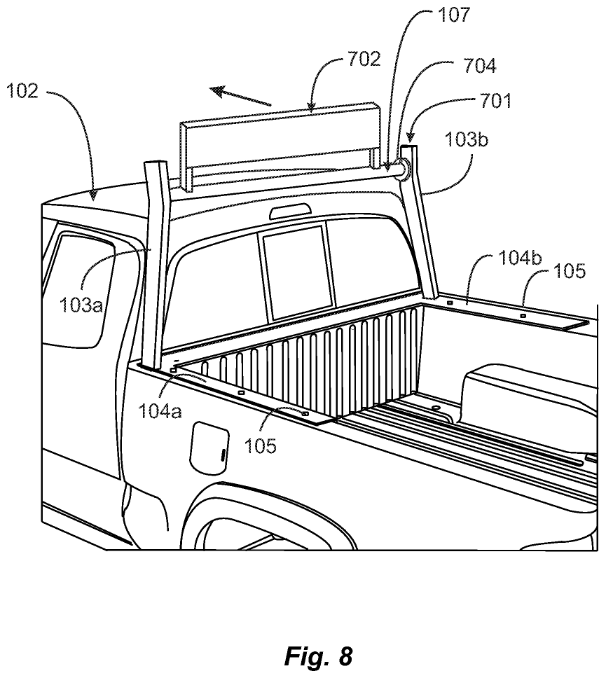

FIG. 8 shows the light bar of FIG. 7 rotated 180 degrees to a vertical position projecting directly upward from top rail 107. The rear window is now unobstructed, and the lights 703 now project forward as shown by the bold arrow. The disk of mechanism 704, having rotated 180 degrees, presents the hole in the disk now at a new position, where a second pin through post 103b my lock the pivot bar in place, with the light bar in the upper position.

Power for the lights in the light bar is provided by the truck battery and generator power through conductors which may be in one or both posts 103a and 103b, and from there into the top rail 107 and into the light bar. Switching may be implemented in the cab of the truck, and in some embodiments integrated with the direction light control of the truck.

In the embodiments described above, both for the cargo rack 106 and for the light bar, the implementations are for a headache rack. However, both the rotating cargo rack and the rotating light bar may be implemented as well for a truck that has a full rack system with posts at all four corners of a truck bed, and not just at the front as with a headache rack.

Descriptions of embodiments of the invention above are exemplary only, and not limiting to the scope of the invention, as there are many more variations in the examples that will fall within the scope of the invention. There are, for example, a variety of ways that the top rail 107 may be implemented and driven, and a variety of ways that stops and locks may be arranged to control where and how both the cargo panel and the light bar, in different embodiments, may be rotated and help in place. The scope is limited only by the claims that follow.

1. A truck rack apparatus, comprising:
a rack framework comprising two vertical posts, one each at opposite sides of a bed of the truck proximate a cab of the truck, the posts extending to a height beyond a height of the cab of the truck;
a top rail spanning between the two vertical posts near an upper extremity of the posts, the top rail mounted to rotate about a horizontal axis between the vertical posts; and
a substantially rectangular planar panel rigidly joined along one edge to the top rail, such that the planar panel is rotatable about the horizontal axis to assume a first position with the plane of the panel vertical, and the panel suspended from the top rail between the vertical posts, occluding a back portion of the cab of the truck, and a second position with the plane of the panel horizontal, projecting over the cab of the truck, serving as a cargo panel for carrying cargo.

2. The truck rack apparatus of claim 1 further comprising a locking mechanism that, engaged, holds the planar panel in the first position.

3. The truck rack apparatus of claim 1 further comprising a stop mechanism joined to one or both of the vertical posts, such that the planar panel, when rotated to the second position encounters the stop mechanism, which constrains the planar panel in the horizontal position over the cab of the truck.

4. The truck rack apparatus of claim 1 wherein the top rail comprises a tubular portion engaging bearings, one proximate each end of the top rail, the bearings engaging a rod spanning between the two vertical posts, such that the tubular portion rotates freely with respect to the rod.

5. The truck rack apparatus of claim 4 wherein the bearings are polymer journal bearings.

6. The truck rack apparatus of claim 1 further comprising an electric motor drive apparatus engaging the top rail, such that the motor engaged in one rotary direction rotates the top rail, moving the planar panel from the first to the second position, and engaged in an opposite rotary direction rotates the planar panel from the second position to the first.

7. The truck rack apparatus of claim 6 wherein the electric motor drive apparatus further a chain and sprocket arrangement, one sprocket engaged to an output shaft of the motor, and a second sprocket engaged to the top rail.

8. The truck rack apparatus of claim 1 wherein the substantially rectangular planar panel has a framework formed of rectangular steel tubing, with a panel of expanded metal joined to the framework.

9. The truck rack apparatus of claim 8 further comprising a plurality of retainer clips joined to the framework, providing attachment points for cargo lines or bungee cords to retain cargo placed on the panel.

10. The truck rack apparatus of claim 1 comprising four vertical posts, one each at each of four corners of the bed of the truck, the posts joined by horizontal rails, providing a full cargo rack system.
